(19) United States
(12) Patent Application Publication
(10) Pub. No.: US 2005/0033012 A1
(43) Pub. Date: Feb. 10, 2005

(54) High temperature resistant fiberfill comprising PETN fibers

(76) Inventors: Arun P. Aneja, Greenville, NC (US); Jill B. Dean, Northallerton (GB)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/634,427

(22) Filed: Aug. 5, 2003

(51) Int. Cl. C08G 63/02

(52) U.S. Cl. 528/272

(57) ABSTRACT

The present invention is directed to fibers comprising a copolymer of polyethylene terephthalate and poly(ethylene napthalate) (PETN). These fibers are used in polyester fiberfill batts, structures and articles made therefrom. Such articles provide superior bulk retention on exposure to high temperature.

### BACKGROUND OF THE INVENTION

The present invention relates to improvements in polyester fiberfill batts, structures and articles made therefrom, and in particular, where the fiberfill comprises a copolymer of polyethylene terephthalate and poly(ethylene napthalate) (PETN). These articles provide superior bulk retention on exposure to high temperature.

### FIELD OF INVENTION

The present invention relates to improvements in polyester fiberfill batts, structures and articles made therefrom. These articles provide superior bulk retention on exposure to high temperature. The articles are suitable for both domestic and industrial end uses, such as pillows, sleeping bags, car seats, boil-washable bedding, insulation, quilts, apparel, filters and the like.

### BACKGROUND OF THE INVENTION

Japanese patent JP 11335452A discloses fibers from naphthalene dicarboxylic and aromatic diol alkylene oxide having improved fatigue resistance. U.S. patent 20020132960A1 discloses binary and ternary blends by mixing of cellulose esters and aliphatic/aromatic copolyesters to obtain fibers. However, neither of these references discloses fibers which are made from a copolymer of poly(ethylene terephthalate) and poly(ethylene napthalate), (PETN). In addition, neither of these references discloses filling materials obtained from the fibers produced.

Combining a flake of poly(ethylene napthalate) and a flake of poly(ethylene terephthalate) has been done to form articles such as bottles and films. With this process, a blend is produced. However, the compositon of the blend depends on the degree of transesterification which occurs during the extrusion process between the poly(ethylene napthalate) and the poly(ethylene terephthalate). Incorporation of naphthalate groups in to the poly(ethylene terephthalate) improves the strength modulus, heat resistance, gas barrier and UV barrier properties.

It is also known in the art that exposure to filling material at high temperature (50-100° C.) greatly reduces bulk retention. This is a major deficiency in applications where the material is subject to high temperatures, e.g., car seats and boil-washable bedding for medical end use. In addition the incumbent material such as polyurethane foam can be difficult to recycle.

### SUMMARY OF THE INVENTION

Applicants have found that fibers comprising a copolymer of poly(ethylene terephthalate) and poly(ethylene napthalate), (PETN) can be used to produce articles which provide superior bulk retention on exposure to high temperature. Preferably, such fibers have a dpf in the range of 1-15. The fibers may be of round and hollow, scalloped oval, trilobal or four-hole cross section. These fibers comprise 5 mole % to 20 mole % naphthalate groups and the remainder of the dicarboxylate groups as terephthalate. Such fibers show the property of superior compression performance of initial bulk (BL₁) and residual bulk (BL₂) than incumbent homopolymer polyester fiberfill.

### BRIEF DESCRIPTION OF THE DRAWINGS

FIG. 1 shows the property of compression performance of initial bulk, BL₁, performance of batts as a function of concentration and of unit naphthalate group (mole %) and temperature.

FIG. 2 shows the the property of compression performance of residual bulk, BL₂, of batts as a function of concentration and of unit napthalate group (mole %) and temperature.

### DETAILED DESCRIPTION OF THE INVENTION

The present invention is directed to fibers comprising a copolymer of poly(ethylene terephthalate) and poly(ethylene napthalate), (PETN). Dimethyl terephthalate (DMT) and naphthalene di carboxylate (NDC) are reacted with ethylene glycol (EG) to form such PETN copolymers. Specifically, DMT is reacted with an excess of EG in the presence of a manganese catalyst. Methanol is distilled from the mixture to give a low molecular weight polyethylene terephthalate (PET) oligomer. Phosphoric acid is then added to this oligomer to deactivate the ester interchange manganese catalyst. Antimony trioxide is added as polycondensation catalyst for the next stage of the reaction. Cobalt acetate is added at this point as a blue color toner for the polymer. The next stage occurs under reduced pressure, and the oligomer chains combine, evolving ethylene glycol. The reaction is complete once the required viscosity of the polymer is achieved. 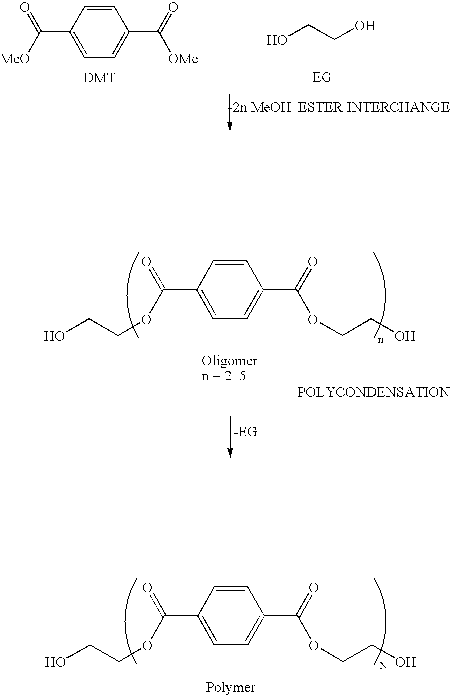
NDC shown below reacts in an analogous manner to DMT.

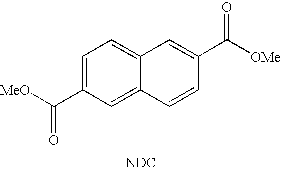

PETN polymers containing 5, 10, 15 and 20 mole % of the acid units as naphthalate may be prepared according to the present invention. PETN5 is taken to mean 5% of the acid units are naphthalate groups, and similar designations can be given for the 10, 15 and 20 % of the acid units being naphthalate groups. The polymer of the present invention is formed into a flake. The flake is then crystallized in a fluid bed to prevent sticking/sintering, then dried and spun into fibers. The fibers of the present invention comprise in the range of 1 mole % to 30 mole % napthalene di-carboxylate and the remainder of the dicarboxylate moieties as terephthalate. The fibers have a denier per filament in the range of 1-30. The fibers may have a round, scalloped oval, hollow, trilobal hollow or four-hole cross section.

The fibers may be drawn and cut to the desired dpf and cut length. The cut fibers are then converted into clusters. The clusters may comprise a blend of dry PETN fibers of the present invention and slickened PETN fibers of the present invention. The clusters are carded and converted into a batt of either a cross-lapped or a vertical folded configuration. The bulk properties of batts of this invention are determined by compressing the clusters ooon an Instron tester and determining the height under load. The test, which is hereinafter referred to as the total bulk range measurement (TBRM) test, is described below, in the Test Methods section. Initial bulk, BL₁, and a residual bulk, BL₂, are measured with this TBRM test. It has been found that preferably, the batts of the present invention have an initial bulk, BL₁, in the range of 4.2 to 5.1, and a residual bulk, BL₂, in the range of 0.47 to 0.50.

In general, Applicants have found that the use of fibers according to the present invention in batts resulted in the following:

BL₁ improves strongly on the addition of naphthate groups.

BL₁ reduces as temperature increases.

BL₁ is insensitive to time of exposure.

BL₂ improves strongly with the addition of naphthalate groups.

BL₂ is insensitive to temperature and time of exposure.

Applicants have found that the optimum concentration for BL₁ is 10 mole % PEN, while for BL₂ it is 20 mole %. This optimum behavior can be linked to the shrinkage properties of the polymer. The amount of polymer chain mobility is linked to the amount the temperature is above T_{g}. As the level of napthalate in the polymer increases, T_{g} increases. Therefore, the polymer chain mobility will decrease for a given temperature above T_{g} with increasing naphthalate content. This reduction in chain mobility could reduce the shrinkage seen in fibers at a given temperature above T_{g}. Therefore, Applicants have found that increasing napthalate content can reduce shrinkage and improve the bulk performance.

Alternatively, increasing the level of naphthalate will reduce the crystallinity that is developed in the polymer. This will reduce the number of pinning points holding the orientated polymer chains in position, so on exposure to heat some of these orientated chains will relax, and the polymer will shrink. In this case increasing the naphthalate level will increase shrinkage and will worsen the bulk properties. With these alternative mechanisms occurring at the same time, one can expect to see a maximum in the bulk performance with increasing naphthalate level.

The invention will be described in greater detail with reference to the following examples which are intended to illustrate the invention without restricting the scope thereof.

### Test Methods

Total bulk range was measured as follows with the TBRM test. This test is carried out by cutting 6-inch (15.25 centimeters) squares from a carded web and adding them to a stack in a cross-lapped manner until their total weight is 20 grams. The entire area is then compressed in an Instron under a load of 50 pounds (22.7 kilograms). The stack height is recorded (after one conditioning cycle under a load of 2 pounds) for heights at loads of 0.001 (for BL₁) and 0.2 (for BL₂) pounds per square inch (0.00007 and 0.014 kilograms per square centimeter, respectively) gage. BL₁ is the initial height, or bulk, and is a measure of filling power, and BL₂ is the height under load, or residual bulk, and is a measure of support.

### EXAMPLE 1

PETN10 was prepared as follows. PETN polymers containing 10 mole % of the end units as naphthalate were prepared in the 40-gallon autoclave and crystallized using the fluid bed. Dimethyl terephthalate (DMT) (63 kg), dimethyl 2,6-naphthalene dicarboxylate (8.8 kg), ethylene glycol (42 L) and manganese acetate. 4H₂O (430 ppm, 29.7 g) were placed in a 40-gallon polymerization reactor under nitrogen. The mixture was heated slowly with stirring and the reflux column mid-point set to 90° C. to enable the methanol generated to be evolved from the reaction. After 20 L of methanol were collected, the column mid-point was set to 220° C. and the reaction temperature increased to 230° C. Once a temperature of 230° C. was achieved 85% phosphoric acid (250 ppm, 20.6 g) in 200 ml ethylene glycol was added and allowed to react in to the mixture for 5 minutes prior to transfer to a second autoclave. Antimony trioxide (400 ppm, 27.8 g) cobalt acetate4H₂O (150 ppm, 10.4 g) in 700 ml ethylene glycol were then added to the reaction mixture. The mixture was heated to 290° C. under vacuum and the polymerization continued until a stirrer kW load of 4.4 was achieved at 40 rpm. The polymer was finally cast into water and chipped to yield approximately 57 kg amorphous polymer.

The flake was crystallized in a fluid bed to prevent sticking/sintering then dried prior to spinning into fibers. The fluid bed conditions were gradually increased from 40-100° C. in 30 min, 110-150° C. in 8 hours, 150-100° C. in 1 hour and 100° C. to 40° C. in 1 hour. The crystallized flake was spun at 280° C. into 18 dpf (nominal) fiber and subsequently drawn to 6 dpf (nominal) fiber. The physical properties were: LVR=16.97, Mod=29.8 gpd, TEN=2.75 g/d, CPI=6.4, CTU=30.8%, BOS=1.2%. The Tg of the flake was 83.4° C. relative to 75° C. for control homopolymer PET of LRV=21.

The drawn fibers were cut, carded and made into batts.

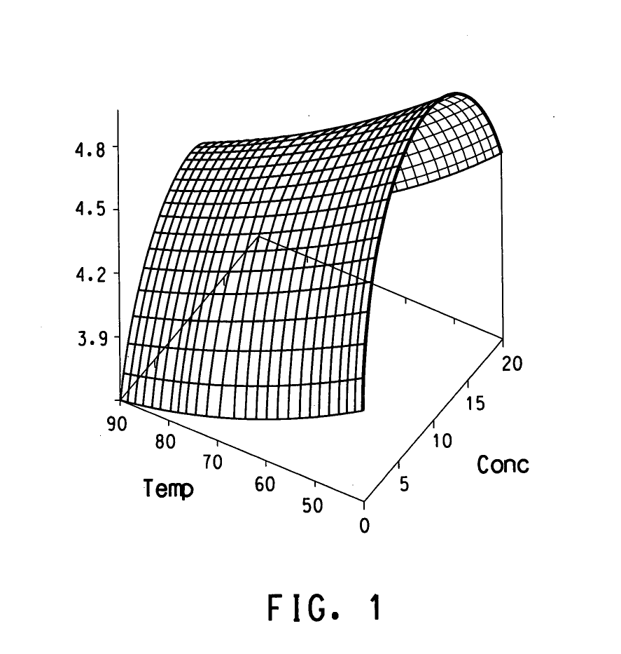

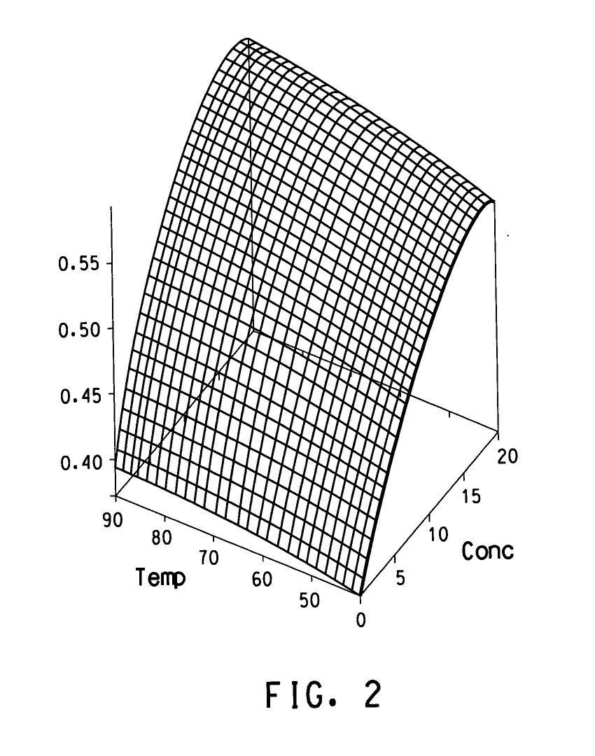

Batts were prepared and then exposed to the following conditions:
0≦Naphthalate Conc(mol %)≦20
40° C.≦Temperature (° C.)≦90° C.
0≦Time (hours)≦72
The samples were withdrawn from the oven at 8-hour frequency. BL₁, initial bulk, at a load of 0.001 lbs, and BL₂, residual bulk at a load of 0.2 lbs, were measured. The results are illustrated in FIGS. 1 and 2.

The performance of the control (batts made from fibers comprising a homopolymer versus batts made from fibers comprising PETN10) on exposure to high temperature at various time intervals is indicated below:

| | Temp. | 8 hrs. | | 24 hrs. | | 48 hrs. | | 72 hrs. | |
|---|---|---|---|---|---|---|---|---|---|
| | ° C. | BL1 | BL2 | BL1 | BL2 | BL1 | BL2 | BL1 | BL2 |
| TDM#8239A | 40 | 3.751 | 0.338 | 4.024 | 0.348 | 4.116 | 0.348 | 4.018 | 0.345 |
| (Control) | | | | | | | | | |
| TDM#8239C | 40 | 5.196 | 0.470 | 5.117 | 0.477 | 5.091 | 0.473 | 5.064 | 0.467 |
| (PETN10) | | | | | | | | | |
| TDM#8239A | 80 | 3.866 | 0.350 | 3.822 | 0.351 | 3.570 | 0.360 | 3.832 | 0.374 |
| (Control) | | | | | | | | | |
| TDM#8239C | 80 | 4.535 | 0.485 | 4.428 | 0.487 | 4.440 | 0.490 | 4.465 | 0.493 |
| (PETN10) | | | | | | | | | |
| TDM#8239A | 90 | 3.588 | 0.355 | 3.496 | 0.371 | 3.420 | 0.345 | 3.358 | 0.363 |
| (Control) | | | | | | | | | |
| TDM#8239C | 90 | 4.518 | 0.498 | 4.366 | 0.505 | 4.640 | 0.509 | 4.239 | 0.501 |
| (PETN10) | | | | | | | | | |

The results indicate that PETN10 fibers show a greater than 25% improvement in BL₁ and greater than 35% improvement on BL₂ on exposure to high temperature versus control.

### EXAMPLE 2, 3 AND 4

PETN5, 15 and 20 copolymers were also prepared in a similar manner to that described above in Example 1. The levels of DMT and NDC were as follows: 66.5 kg of DMT and 4.4 kg of NDC were used; for PETN15, 59.5 kg of DMT and 13.2 kg of NDC were used; and for PETN20, 56 kg of DMT and 17.6 kg of NDC were used. For all of these polymers, and for the polymers prepared in Example 1, a mole ratio of 2.1:1 was used, i.e., 2.1 moles of alcohol were added for every mole of dimethylester.

Drawn fibers were produced, cut, carded and made into batts. BL₁ and BL₂ were measured as described above, and the measurements are shown in FIGS. 1 and 2.

1. Fibers comprising a copolymer of poly(ethylene terephthalate) and poly(ethylene napthalate), (PETN).

2. PETN fibers according to claim 1, wherein the fibers comprise in the range of 1 mole % to 30 mole % naphthalene dicarboxylate and the remainder of the dicarboxylate moieties as terephthalate.

3. PETN fibers according to claim 1, wherein the fibers have a denier per filament in the range of 1- 30.

4. PETN fibers according to claim 1, wherein the fibers have a round, scalloped oval, hollow, trilobal hollow or four-hole cross section.

5. Clusters comprising PETN fibers according to claim 1.

6. Clusters comprising a blend of dry PETN fibers according to claim 1 and slickened PETN fibers according to claim 1.

7. A batt comprising PETN fibers according to claim 1 in either a cross-lapped or vertical folded configuration.

8. The batt according to claim 7, having an initial bulk (BL1) in the range of 4.2 to 5.1.

9. The batt according to claim 7, having a residual bulk (BL2) in the range of 0.47 to 0.50.

10. A process for making fibers comprising a copolymer of polyethylene terephthalate and poly(ethylene napthalate) (PETN), including reacting dimethyl terephthalate (DMT) and naphthalene dicarboxylate (NDC) with ethylene glycol.
